(19) United States
(12) Patent Application Publication
(10) Pub. No.: US 2025/0186924 A1
(43) Pub. Date: Jun. 12, 2025

(54) AIR PURIFICATION FILTER ELEMENT STRUCTURE

(71) Applicant: Zhongshan Lvyuan Environmental Purification Technology Co., Ltd., Zhongshan (CN)

(72) Inventor: Min ZHONG, Zhongshan (CN)

(73) Assignee: Zhongshan Lvyuan Environmental Purification Technology Co., Ltd., Zhongshan (CN)

(21) Appl. No.: 19/056,675

(22) Filed: Feb. 18, 2025

(30) Foreign Application Priority Data
Jan. 6, 2025 (CN) 202520017274.5

(51) Int. Cl. B01D 46/00; B01D 46/52

(52) U.S. Cl. CPC B01D 46/0016; B01D 46/521

(57) ABSTRACT

The present invention discloses an air purification filter element structure, comprising a first mounting plate and a second mounting plate for mounting a filter element, a support mechanism is provided between the first mounting plate and the second mounting plate for supporting the first mounting plate and the second mounting plates. The support mechanism enables the first and second mounting plates to have expanded and folded states. The first and second mounting plates are supported by the support mechanism; the filter element is mounted in the first mounting plate and the second mounting plate and remains the expanded state, thus to facilitate to install the air purification filter element structure into the outer frame of the air purification filter element structure. The first and second mounting plates cancel barbs and guide rail structure, which makes the first and second mounting plates easier to manufacture.

### RELATED APPLICATIONS

The present patent document claims the benefit of priority to patent application No. 202520017274.5, filed Jan. 6, 2025, and entitled “AIR PURIFICATION FILTER ELEMENT STRUCTURE,” the entire contents of each of which are incorporated herein by reference.

### BACKGROUND

### 1. Technical Field

The present invention relates to the technical field of air purification, and in particular to an air purification filter element structure.

### 2. Background Information

With the development of society and the acceleration of industrialization, urban industrialization produces a large number of harmful gases, causing fog and haze; people are increasingly concerned about air purification, and have developed a fresh air system used for purifying air, and the fresh air system is mounted in factories and large supermarkets for purifying air. The fresh air system can reduce concentrations of suspended particles, harmful gases and other pollutants in the air, thereby reducing respiratory diseases, cardiovascular diseases and other health risks associated with air pollution. In the existing technology, the fresh air system is generally provided with an inlet and an outlet, and an air purification filter element structure is provided between the inlet and the outlet. A mounting plate on the air purification filter element structure and an outer frame of the air purification filter element structure are usually connected by barbs and guide rails, which makes it more complicated to manufacture the mounting plates on the air purification filter element structure and the outer frame of the air purification filter element structure. Besides, there is a lack of support mechanism between the two mounting plates, which is easy to overturn.

### BRIEF SUMMARY

In order to overcome the problems that the mounting plate on the air purification filter element structure and the outer frame of the air purification filter element structure are generally connected by barbs and guide rails, which makes it more complicated to manufacture the mounting plate on the air purification filter element structure and the outer frame of the air purification filter element structure, and there is a lack of support mechanism between the two mounting plates, which is easy to overturn. The present invention provides an air purification filter element structure to solve the above technical problems, and the present invention is achieved by the following technical solutions.

An air purification filter element structure comprises a first mounting plate and a second mounting plate used for mounting a filter element, wherein a support mechanism is provided between the first mounting plate and the second mounting plate for supporting the first mounting plate and the second mounting plate, and the support mechanism enables the first mounting plate and the second mounting plate to have expanded and folded states.

The air purification filter element structure as described above, the support mechanism includes a first connector used for connecting with the first mounting plate and a second connector used for connecting with the second mounting plate, and the first connector and the second connector are hinged with each other and capable of being locked.

The air purification filter element structure as described above, a locking portion capable of locking the expanded state of the first mounting plate and the second mounting plate is provided between the first connector and the second connector, the locking portion includes a first locking portion arranged on the first connector and a second locking portion arranged on the second connector.

The air purification filter element structure as described above, the first locking portion is provided with a locking protrusion used for cooperatively locking with the second locking portion, and the locking protrusion is arranged on an outer side of an end of the first connector. The second locking portion is provided with a locking slot used for cooperatively locking with the locking protrusion, the locking slot is provided with a first inclined surface and a first arc surface which enable the locking protrusion to enter the locking slot, the locking slot penetrates both sides of the second connector and is arranged on an outer side of the locking portion with the locking protrusion correspondingly.

The air purification filter element structure as described above, the support mechanism includes a third connector used for connecting with the first mounting plate and a fifth connector used for connecting with the second mounting plate, the third connector can extend into the fifth connector and lock the expanded and folded states of the third connector and the fifth connector.

The air purification filter element structure as described above, a telescoping-locking portion that allows the third connecting portion to telescope and lock on the fifth connecting portion is provided between the third connecting portion and the fifth connecting portion, the telescoping-locking portion includes a first engaging portion arranged on the third connector used for engaging with the fifth connector and a second engaging portion arranged on the fifth connector used for sleeving the third connector and mutually engaging with the third connector.

The air purification filter element structure as described above, the connection between the support mechanism and the first mounting plate the second mounting plate is provided with a height adjusting mechanism that can adjust a height between the first mounting plate and the second mounting plate and lock the height between the first mounting plate and the second mounting plate.

The air purification filter element structure as described above, the support mechanism includes a locking support mechanism body, one side of the locking support mechanism body is provided with a first locking connection portion used for connecting with the first mounting plate and capable of being locked, and the other side is provided with a second locking connection portion used for connecting with the second mounting plate and capable of being locked.

The air purification filter element structure as described above, the first locking connection portion includes a first locking disk arranged on the first mounting plate and a first matching lock lever arranged on the locking support mechanism body for cooperating with the first locking disk to lock the locking support mechanism body from moving. A first latching piece used for latching the first locking disk and the first matching lock lever is provided between the first locking disk and the first matching lock lever. A disk hole for the insertion of the first latching piece is provided on the first locking disk, and a first lock lever hole for the insertion of the first latching piece is provided on the first matching lock lever. The second locking connection portion includes a second locking disk arranged on the second mounting plate and a second matching lock lever arranged on the locking support mechanism body for cooperating with the second locking disk to lock the locking support mechanism body from moving. A second latching piece for locking the second locking disk and the second matching lock lever is provided between the second locking disk and the second cooperating lock lever. A second disk hole for the insertion of the second latching piece is provided on the second locking disk, and a second lock lever hole for the insertion of the second latching piece is provided on the second cooperating lock lever.

Compared with the prior art, the present invention has at least the following beneficial effects.

The first mounting plate and the second mounting plate are supported through the support mechanism, and the filter element is mounted into the first mounting plate and the second mounting plate and remains the expanded state, thus to facilitate to install the air purification filter element structure into the outer frame of the air purification filter element structure. The first mounting plate and the second mounting plate cancel barbs and guide rail structure, which makes the first mounting plate and the second mounting plate easier to manufacture. Besides, the air purification filter element structure remains the expanded state stably when it is installed into and removed from the outer frame of the air purification filter element structure, which is convenient for assembly and disassembly.

The support mechanism enables the first mounting plate and the second mounting plate to have expanded and folded states, so that the support mechanism can not only support the expanded state of the first mounting plate and the second mounting plate, but also can be folded to reduce occupied space and facilitate transportation.

The support mechanism and the first mounting plate and the second mounting plate adjust the height between the first mounting plate and the second mounting plate by means of rotational locking, and users can adjust the height between the first mounting plate and the second mounting plate according to the actual demands, which brings more convenience to the users.

### BRIEF DESCRIPTION OF THE DRAWINGS

In order to illustrate the technical solutions in the embodiments of the present invention more clearly, the accompany drawings required in the descriptions of the embodiments will be briefly introduced hereafter.

FIG. 1 is a front schematic diagram of an air purification filter element structure according to embodiment 2 of the present invention.

FIG. 2 is a folded schematic diagram of the air purification filter element structure according to embodiment 2 of the present invention.

FIG. 3 is a schematic diagram of the air purification filter element structure according to embodiment 1 of the present invention.

FIG. 4 is another schematic diagram of the air purification filter element structure according to embodiment 1 of the present invention.

FIG. 5 is a schematic diagram of the air purification filter element structure according to embodiment 3 of the present invention.

FIG. 6 is an internal schematic diagram of a third connector of the air purification filter element structure in embodiment 3 of the present invention.

FIG. 7 is a front schematic diagram of an air purification filter element structure according to embodiment 4 of the present invention.

FIG. 8 is a stereoscopic schematic diagram of the air purification filter element structure according to embodiment 2 of the present invention.

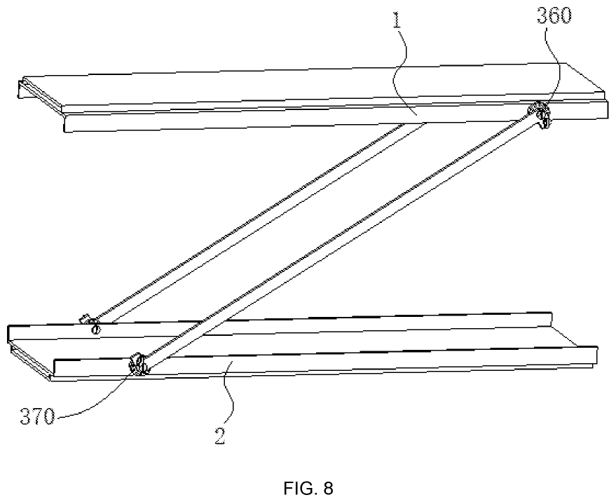

FIG. 9 is a schematic diagram of a first locking disk of the air purification filter element structure in embodiment 2 of the present invention.

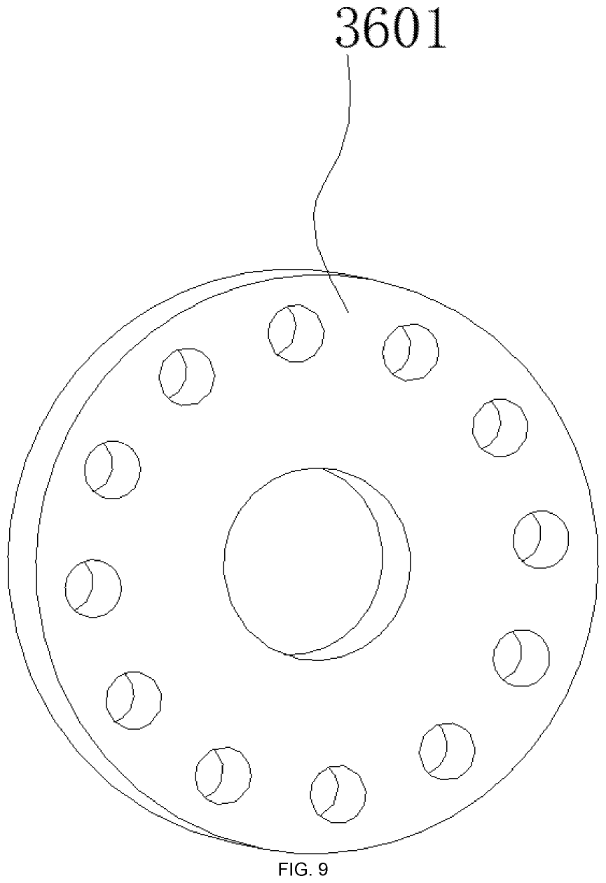

FIG. 10 is a schematic diagram of a first matching lock lever of the air purification filter element structure in embodiment 2 of the present invention.

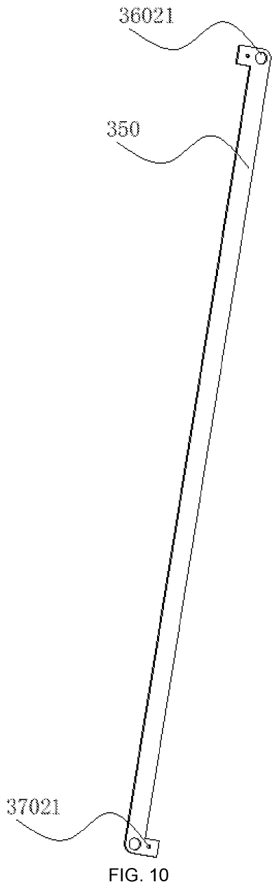

FIG. 11 is a schematic diagram of a first latching piece of the air purification filter element structure in embodiment 2 of the present invention.

### DETAILED DESCRIPTION OF THE DRAWINGS AND THE PRESENTLY PREFERRED EMBODIMENTS

In order to make the technical problems, technical solutions and beneficial effects solved by the present invention more clearly, the present invention is further illustrated hereafter in combination with the accompany drawings and embodiments. It should be understood that the embodiments described here are only used for explaining the present invention but not to limit the present invention.

### Embodiment 1

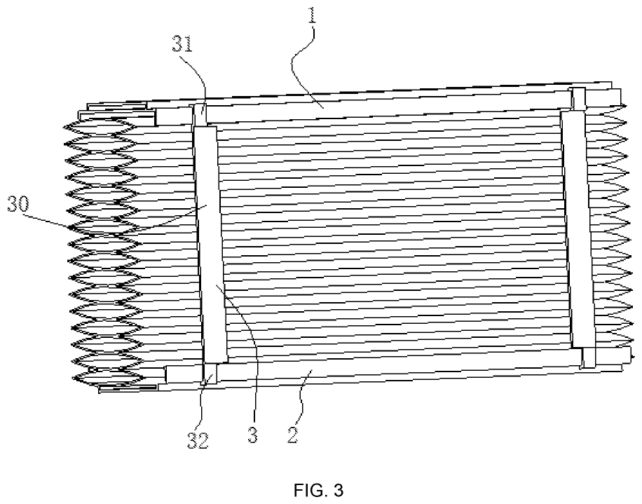

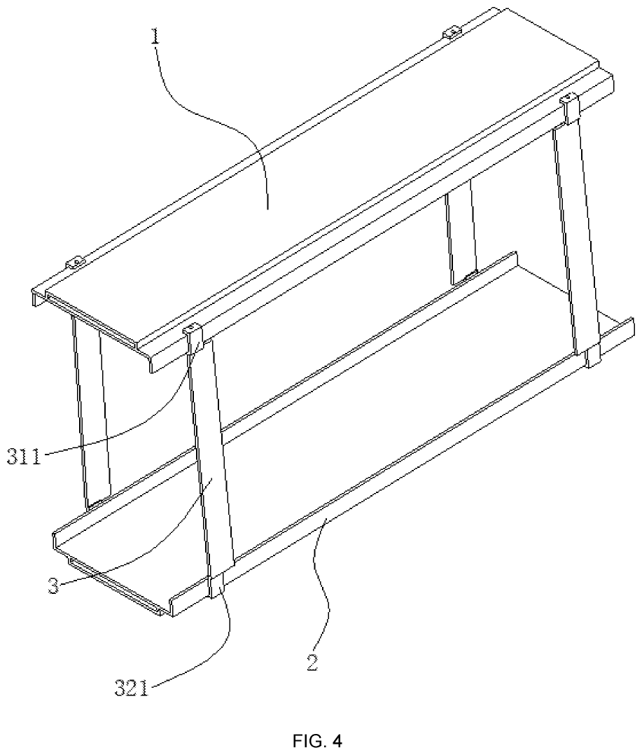

Please refer to FIGS. 3 and 4, an air purification filter element structure comprises a first mounting plate 1 and a second mounting plate 2 used for mounting a filter element, wherein a support mechanism 3 is provided between the first mounting plate 1 and the second mounting plate 2 for supporting the first mounting plate 1 and the second mounting plate 2. The first mounting plate and the second mounting plate cancel barbs and guide rail structure, so that the first mounting plate and the second mounting plate are simper to manufacture. The filter element is composed of non-woven fabric, one side of the filter element is connected to the first mounting plate, and the other side is connected to the second mounting plate, so that the filter element can be expanded and folded together with the first mounting plate and the second mounting plate, which can effectively filter pollutants in the air. The support mechanism can simplify the installation and replacement processes of the air purification filter element structure, the existence of the support mechanism can provide supporting force, so that the filter element structure is not easy to deform or shift during use, especially in the face of high wind speed or long-term operation, it can remain its shape and performance, which is easy to disassemble and convenient to replace or check the filter element.

Further, as a preferred implementation method of this solution rather than a limitation, the support mechanism 3 includes a support mechanism body 30, a first connecting portion 31 used for connecting with the first mounting plate 1 and a second connecting portion 32 used for connecting with the second mounting plate 2. The support mechanism body 30 is a rod. The first connecting portion 31 is provided with a first matching connection groove 311 which is correspondingly and cooperatively connected with the first mounting plate 1. The first matching connection groove 311 is provided with a first mounting hole 3111 used for mounting a fastener. The fastener can be a bolt. The second connecting portion 32 is provided with a second matching connection groove 321 which is correspondingly and cooperatively connected with the second mounting plate 2. The second matching connection groove 321 is provided with a second mounting hole 3211 used for mounting the fastener.

Further, as a preferred implementation method of this solution rather than a limitation, each width of the first matching connection groove 311 and the second matching connection groove 321 is smaller than that of the support mechanism body 30, which is beneficial for reducing the use of raw materials and saving materials.

### Embodiment 2

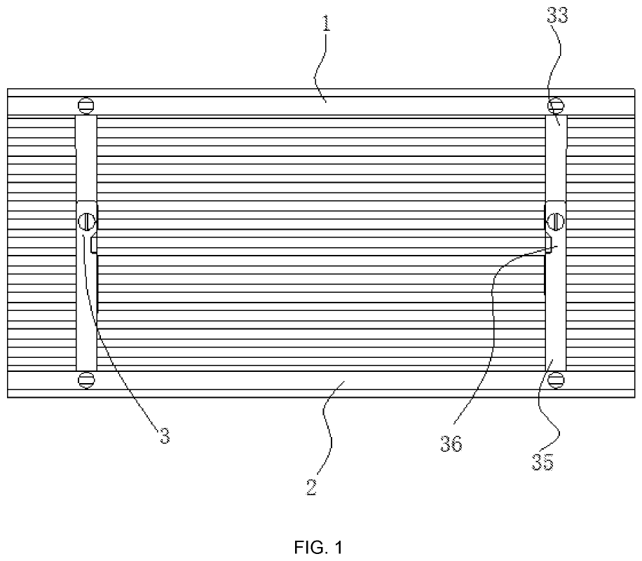

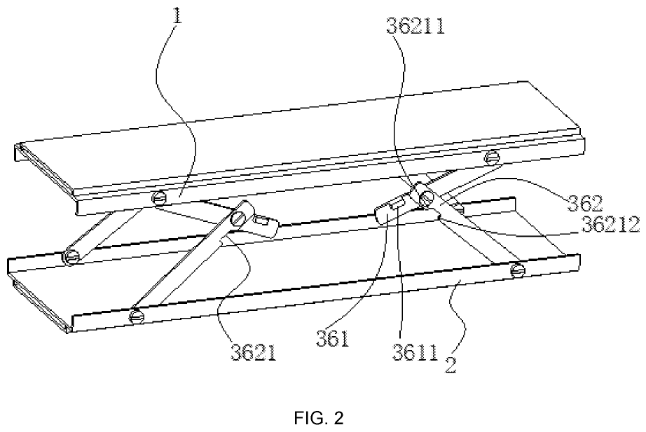

Please refer to FIGS. 1-2, the difference between Embodiment 2 and Embodiment 1 is that the support mechanism 3 enables the first mounting plate 1 and the second mounting plate 2 to have expanded and folded state, the support mechanism 3 can not only support the expanded state of the first mounting plate 1 and the second mounting plate 2, but also can be folded to reduce the occupied space and facilitate transportation.

Further, as a preferred implementation method of this solution rather than a limitation, the support mechanism 3 includes a first connector 33 used for connecting with the first mounting plate 1 and a second connector 35 used for connecting with the second mounting plate 2. The first connector 33 and the second connector 35 are hinged with each other and can be locked.

Further, as a preferred implementation method of this solution rather than a limitation, a locking portion 36 capable of locking the expanded state of the first mounting plate 1 and the second mounting plate 2 is provided between the first connector 33 and the second connector 35. The locking portion 36 includes a first locking portion 361 arranged on the first connector 33 and a second locking portion 362 arranged on the second connector 35. The first locking portion 361 and the second locking portion 362 are locked when the support mechanism 3 is expanded, and the locking is released when the support mechanism is folded.

Further, as a preferred implementation method of this solution rather than a limitation, the first locking portion 361 is provided with a locking protrusion 3611 used for cooperatively locking with the second locking portion 362, and the locking protrusion 3611 is arranged on an outer side of one end of the first connector 33. The second locking portion 362 is provided with a locking slot 3621 for cooperatively locking with the locking protrusion 3611. The locking slot 3621 is provided with a first inclined surface 36211 and a first arc surface 36121 that enable the locking protrusion 3611 to enter the locking slot 3621. The locking slot 3621 penetrates both sides of the second connector 35 and is correspondingly arranged on an outer side of the locking portion 36 together with the locking protrusion 3611. The structures of the locking slot 3621 and the locking protrusion 3611 are simple, and the locking and unlocking of the first connector 33 and the second connector 35 can be realized simultaneously.

Further, as a preferred implementation method of this solution rather than a limitation, the first connector 33 and the second connector 35 approach each other with a hinge point as a rotational center when the locking portion 36 is unlocked, so that the first mounting plate 1 and the second mounting plate 2 can approach each other, and thus the folding of the whole device can be realized, which is convenient for the users to carry and save space.

### Embodiment 3

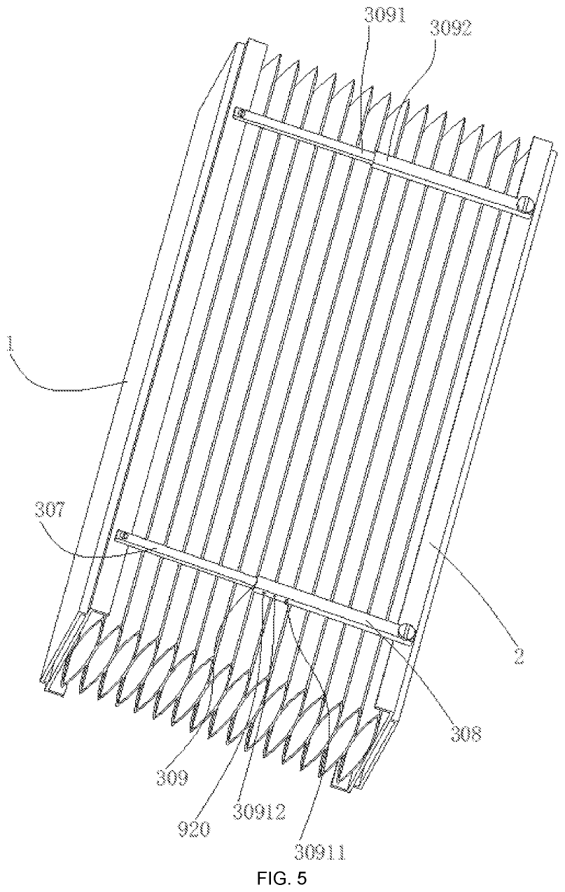

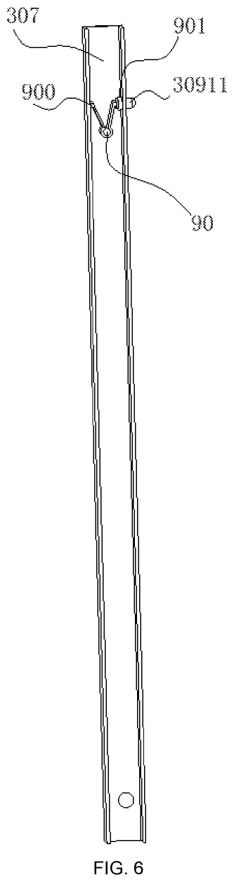

Please refer to FIGS. 5 and 6, the difference between Embodiment 3 and Embodiment 2 is that the support mechanism 3 includes a third connector 307 used for connecting with the first mounting plate 1 and a fifth connector 308 used for connecting with the second mounting plate 2. The third connector 307 can extend into the fifth connector 308 and can lock the expanded and folded states of the third connector 307 and the fifth connector 308. The third connector 307 can be telescoped and locked in the fifth connector 308.

Further, as a preferred implementation method of this solution rather than a limitation, a telescoping-locking portion 309 that enables the third connector 307 to telescope and lock on the fifth connector 308 is provided between the third connector 307 and the fifth connector 308. The telescoping-locking portion 309 includes a first engaging portion 3091 arranged on the third connector 307 for engaging with the fifth connector 308 and a second engaging portion 3092 arranged on the fifth connector 308 for sleeving the third connector 307 and mutually engaging with the third connector 307.

Further, as a preferred implementation method of this solution rather than a limitation, the first engaging portion 3091 includes an engaging protrusion 30911 that can telescope within the third connector 307 and an extending hole 30912 through which the engaging protrusion 30911 extends. The engaging protrusion 30911 is connected with a spring plate 900 that enables the engaging protrusion 30911 to reset, the spring plate 900 is connected with a first fixing post 90 arranged on the third connector 307, and the first fixing post 90 provides support for the spring plate 900. A guiding hollow post 901 is provided on an outer side of the engaging protrusion 30911 to prevent the engaging protrusion from deviating.

Further, as a preferred implementation method of this solution rather than a limitation, the second engaging portion 3092 is provided with a first locking hole 920 through which the engaging protrusion 30911 extends out of the fifth connector 308 so that the third connector 307 and the fifth connector 308 can be locked. An aperture of the first locking hole 920 is larger than a diameter of the engaging protrusion 30911. The setting of multiple first locking holes can adjust the length between the third connector and the fifth connector, thus to adjust the distance between the first mounting plate and the second mounting plate, which saves the space of the filter element structure and facilitates transportation.

### Embodiment 4

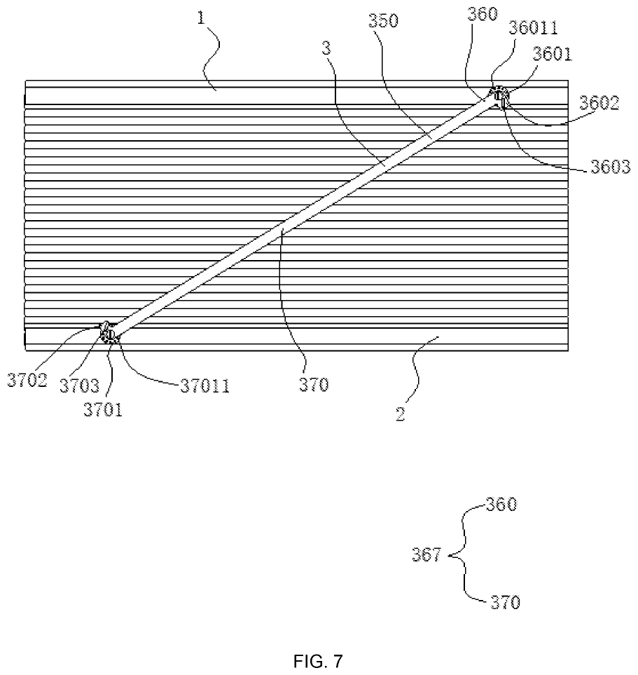

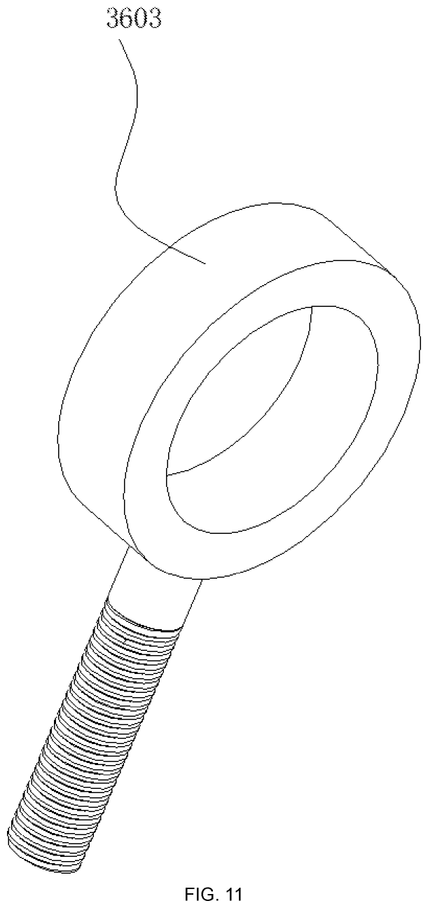

Please refer to FIGS. 7 and 11, the difference between Embodiment 4 and Embodiment 1 is that the connection between the support mechanism 3 and the first mounting plate 1 and the second mounting plate 2 is provided with a height adjusting mechanism 367 that can adjust a height between the first mounting plate 1 and the second mounting plate 2 and lock the height between the first mounting plate 1 and the second mounting plate 2. Through the height adjusting mechanism 367, the users can adjust the height between the first mounting plate 1 and the second mounting plate 2 according to the actual demands, which brings more convenience to the users.

Further, as a preferred implementation method of this solution rather than a limitation, the support mechanism 3 includes a locking support mechanism body 350, one side of the locking support mechanism body 350 is provided with a first locking connection portion 360 for connecting with the first mounting plate 1 and capable of being locked, and the other side is provided with a second locking connection portion 370 for connecting with the second mounting plate 2 and capable of being locked. The distance between the first mounting plate 1 and the second mounting plate 2 can be adjusted and the first mounting plate 1 can be supported through the first locking connection portion 360 and the second locking connection portion 370. The locking support mechanism body is a rod.

Further, as a preferred implementation method of this solution rather than a limitation, the first locking connection portion 360 includes a first locking disk 3601 arranged on the first mounting plate 1 and a first matching lock lever 3602 arranged on the locking support mechanism body 350 for cooperating with the first locking disk 3601 to lock the locking support mechanism body 350 from moving. A first latching piece 3603 used for latching the first locking disk 3601 and the first matching lock lever 3602 is provided between the first locking disk 3601 and the first matching lock lever 3602. A disk hole 36011 for the insertion of the first latching piece 3603 is provided on the first locking disk 3601, and a first lock lever hole 36021 for the insertion of the first latching piece 3603 is provided on the first matching lock lever 3602. The first locking disk 3601 is fixed on the first mounting plate 1. A diameter of the first disk hole is the same as that of the first lock lever hole, and the first latching piece is inserted into the first disk hole and the first lock lever hole to achieve the locked positional state of the first mounting plate and the locking support mechanism body.

Further, as a preferred implementation method of this solution rather than a limitation, the second locking connection portion 370 includes a second locking disk 3701 arranged on the second mounting plate 2 and a second matching lock lever 3702 arranged on the locking support mechanism body 350 for cooperating with the second locking disk 3701 to lock the locking support mechanism body 350 from moving. A second latching piece 3703 for locking the second locking disk 3701 and the second matching lock lever 3702 is provided between the second locking disk 3701 and the second cooperating lock lever 3702. A second disk hole 37011 for the insertion of the second latching piece 3703 is provided on the second locking disk 3701, and a second lock lever hole 37011 for the insertion of the second latching piece 3703 is provided on the second cooperating lock lever 3702. The second locking disk 3701 is fixed on the second mounting plate 2. A diameter of the second disk hole is the same as that of the second lock lever hole, and the second latching piece is inserted into the second disk hole and the second lock lever hole to achieve the locked positional state of the second mounting plate and the locking support mechanism body.

The working principles of the embodiments are as follows.

In embodiment 1 of the air purification filter element structure, the support mechanism is a rod structure, so that the filter element remains the expanded state between the first mounting plate 1 and the second mounting plate 2, which can simplify the installation and replacement processes of the filter element structure.

In embodiment 2, the support mechanism 3 enables the first mounting plate 1 and the second mounting plate 2 to have expanded and folded states. The first connector 33 and the second connector 35 are hinged with each other and can be locked. The locking and unlocking of the first connector and the second connector can be achieved through the rotation of the structure of the locking slot 3621 and the locking protrusion 3611.

In embodiment 3, the support mechanism 3 realizes the expansion and folding of the support mechanism 3 by means of telescoping, and the third connector 307 can be telescoped and locked in the fifth connector 308.

In embodiment 4, the support mechanism 3 and the first mounting plate 1 and the second mounting plate 2 can adjust the height between the first mounting plate 1 and the second mounting plate 2 by means of rotational locking. The connection between the support mechanism 3 and the first mounting plate 1 the second mounting plate 2 is provided with a height adjusting mechanism 367 that can adjust the height between the first mounting plate 1 and the second mounting plate 2 and lock the height between the first mounting plate 1 and the second mounting plate 2. Through the height adjusting mechanisms 367, users can adjust the height between the first mounting plate 1 and the second mounting plate according to the actual demands.

The above described are implementation methods provided in combination with the specific contents, and it is not determined that the specific embodiments of the present invention are limited to these descriptions. Any methods and structures that are similar to the present invention, or any technical deductions or substitutions made under the premises of the present invention, should be regarded as the protection scope of the present invention.

1. An air purification filter element structure, comprising a first mounting plate and a second mounting plate used for mounting a filter element, wherein a support mechanism is provided between the first mounting plate and the second mounting plate for supporting the first mounting plate and the second mounting plate;
and the support mechanism enables the first mounting plate and the second mounting plate to have expanded and folded states.

2. The air purification filter element structure according to claim 1, wherein the support mechanism includes a first connector used for connecting with the first mounting plate and a second connector used for connecting with the second mounting plate, and the first connector and the second connector are hinged with each other and capable of being locked.

3. The air purification filter element structure according to claim 2, wherein a locking portion capable of locking the expanded state of the first mounting plate and the second mounting plate is provided between the first connector and the second connector, the locking portion includes a first locking portion arranged on the first connector and a second locking portion arranged on the second connector.

4. The air purification filter element structure according to claim 3, wherein the first locking portion is provided with a locking protrusion used for cooperatively locking with the second locking portion, and the locking protrusion is arranged on an outer side of an end of the first connector.

5. The air purification filter element structure according to claim 4, wherein the second locking portion is provided with a locking slot used for cooperatively locking with the locking protrusion, the locking slot is provided with a first inclined surface and a first arc surface which enable the locking protrusion to enter the locking slot, the locking slot penetrates both sides of the second connector and is correspondingly arranged on an outer side of the locking portion along with the locking protrusion.

6. The air purification filter element structure according to claim 5, wherein the first connector and the second connector approach each other with a hinge point as a rotational center when the locking portion is unlocked, further the first mounting plate and the second mounting plate approach each other, and the whole structure is folded.

7. The air purification filter element structure according to claim 1, wherein the support mechanism includes a third connector used for connecting with the first mounting plate and a fifth connector used for connecting with the second mounting plate, the third connector is able to extend into the fifth connector and lock the expanded and folded states of the third connector and the fifth connector.

8. The air purification filter element structure according to claim 7, wherein a telescoping-locking portion that enables the third connecting portion to telescope along and lock on the fifth connecting portion is provided between the third connecting portion and the fifth connecting portion, the telescoping-locking portion includes a first engaging portion arranged on the third connector for engaging with the fifth connector and a second engaging portion arranged on the fifth connector for sleeving the third connector and mutually engaging with the third connector.

9. The air purification filter element structure according to claim 8, wherein the first engaging portion includes an engaging protrusion that telescopes within the third connector and an extending hole through which the engaging protrusion extends,
the engaging protrusion is connected with a spring plate that enables the engaging protrusion to reset, the spring plate is connected with a first fixing post arranged on the third connector, and the first fixing post provides support for the spring plate,
a guiding hollow post is provided on an outer side of the engaging protrusion to prevent the engaging protrusion from deviating.

10. The air purification filter element structure according to claim 9, wherein the second engaging portion is provided with a first locking hole through which the engaging protrusion extends out of the fifth connector so that the third connector and the fifth connector are locked, an aperture of the first locking hole is larger than a diameter of the engaging protrusion.

11. The air purification filter element structure according to claim 1, wherein a height adjusting mechanism is provided at connections between the support mechanism and the first and second mounting plate, which is configured to adjust a height between the first mounting plate and the second mounting plate and lock a height between the first mounting plate and the second mounting plate.

12. The air purification filter element structure according to claim 11, wherein the support mechanism includes a locking support mechanism body, one side of the locking support mechanism body is provided with a first locking connection portion for connecting with the first mounting plate and capable of being locked, and the other side is provided with a second locking connection portion for connecting with the second mounting plate and capable of being locked.

13. The air purification filter element structure according to claim 12, wherein the first locking connection portion includes a first locking disk arranged on the first mounting plate and a first matching lock lever arranged on the locking support mechanism body for cooperating with the first locking disk to lock the locking support mechanism body from moving;
a first latching piece used for latching the first locking disk and the first matching lock lever is provided between the first locking disk and the first matching lock lever; a disk hole for the insertion of the first latching piece is provided on the first locking disk, and a first lock lever hole for the insertion of the first latching piece is provided on the first matching lock lever;
wherein the second locking connection portion includes a second locking disk arranged on the second mounting plate and a second matching lock lever arranged on the locking support mechanism body for cooperating with the second locking disk to lock the locking support mechanism body from moving;
a second latching piece for locking the second locking disk and the second matching lock lever is provided between the second locking disk and the second cooperating lock lever; a second disk hole for the insertion of the second latching piece is provided on the second locking disk, and a second lock lever hole for the insertion of the second latching piece is provided on the second cooperating lock lever.

14. The air purification filter element structure according to claim 1, wherein the support mechanism includes a support mechanism body, a first connecting portion used for connecting with the first mounting plate and a second connecting portion used for connecting with the second mounting plate,
the first connecting portion is provided with a first matching connection groove which is correspondingly and cooperatively connected with the first mounting plate, the first matching connection groove is provided with a first mounting hole used for mounting a fastener,
the second connecting portion is provided with a second matching connection groove which is correspondingly and cooperatively connected with the second mounting plate, the second matching connection groove is provided with a second mounting hole used for mounting the fastener.

15. The air purification filter element structure according to claim 14, wherein each width of the first matching connection groove and the second matching connection groove is smaller than that of the support mechanism body.
